(19) United States
(12) Patent Application Publication
(10) Pub. No.: US 2006/0282610 A1
(43) Pub. Date: Dec. 14, 2006

(54) Flash memory with programmable endurance

(75) Inventors: Dani Dariel, Yishuvei Gederot (IL); Menahem Lasser, Kohav - Yair (IL)

Correspondence Address: DR.MARK FRIEDMAN LTD.;C/o Bill Polkinghorn, 9003 Florin Way, Upper Marlboro, MD, 20772, US

(73) Assignee: M-SYSTEMS FLASH DISK PIONEERS LTD.

(21) Appl. No.: 11/271,880

(22) Filed: Nov. 14, 2005

Related U.S. Application Data
(60) Provisional application No. 60/688,233, filed on Jun. 8, 2005.

(51) Int. Cl. G06F 12/00

(52) U.S. Cl. 711/103; 711/173

(57) ABSTRACT

Non-volatile memory devices, systems, methods and computer readable code for configuring at least a portion of a non-volatile memory to provide a requested effective endurance are disclosed. According to some embodiments, a determined amount of physical memory is allocated for the at least a portion of non-volatile memory. According to some embodiments, for a given amount of configured physical memory, requesting a greater effective endurance provides a smaller amount of logically addressable memory. According to some embodiments, for a given amount of logically addressable memory, requesting a greater effective endurance configures a greater amount of physical memory. In some embodiments, a controller is operative to configure the at least a portion of non-volatile memory. Alternatively or additionally, driver code resides on a host device coupled to the non-volatile memory device. Optionally, a value of the requested endurance is specified in a command issued to the non-volatile memory device. According to some embodiments, the command may be issued at a time of manufacture and/or at a runtime of the non-volatile memory device. Exemplary non-volatile memory that may be configured includes but is not limited to NAND flash memory, NOR flash memory, and EEPROM memory.

### CROSS-REFERENCE TO RELATED APPLICATIONS

This patent application claims the benefit of U.S. Provisional Patent Application No. 60/688,233, filed Jun. 8, 2005 by the present inventors.

### FIELD OF THE INVENTION

The present invention relates to non-volatile memory devices such as flash memory devices.

### BACKGROUND OF THE INVENTION

Non-Volatile Memory

Non-volatile memory is a type of memory that can retain its stored data without a power source. There are several types of non-volatile memories, differentiated by read, write and erase capabilities, access times, data retention, and data endurance cycles. Electrically Erasable Programmable Read Only Memory (EEPROM) is capable of performing read write operations on a per-byte level, meaning each of the memory locations can be individually read and written.

Flash memory, comprised of flash-type floating-gate transistors, is a non-volatile memory similar in functionality and performance to EEPROM memory; flash memory has the advantage of being relatively inexpensive, although it operates under certain limitations. It is not possible to rewrite to a previously written location on flash memory without first erasing an entire memory section, i.e., the flash cells must be erased (e.g. programmed to “one”) before they can be programmed again. Flash memory can only erase relatively large groups of cells, usually called erase blocks (typically 16 to 128 KB in size for current commercial devices). Therefore updating the contents of a single byte or even a chunk of 1 KB requires housekeeping operations—the parts of the erase block that are not updated must first be moved elsewhere so they will be preserved during the erase operation, and then moved back into place after the update.

Electrically erasable non-volatile memory suffers from wear when subjected to write and erase operations. Each memory location can withstand a limited number of write/erase cycles. Areas of the flash that are written to more than the specified number of times are unreliable, and data read from an overused location may be incorrect. The number of write operations a non-volatile memory area can withstand before becoming unreliable is called endurance. A typical endurance level is 100,000 write/erase cycles. The endurance level is guaranteed by the device manufacturer, and is a worst-case number; in practice, most of the cells contained in the flash memory are likely to withstand a much higher number of write/erase cycles.

Flash memory is further categorized into NOR and NAND flash, based on the type of memory cells interconnection architecture used. The cost per bit for NAND flash is lower then that of NOR flash. However, NAND flash memory is limited to block read and write operations, as compared to a NOR flash memory that is capable of read and possibly write operations at the byte level, provided that the written location is erased (i.e. it contains all “ones”). Furthermore, typical NAND flash memory contains a small portion of bad blocks, which are not reliable and should not be used to store data. Bad blocks are verified either by the manufacturer when initially testing the flash memory, or by software when detecting the failure of a block during use in the field.

To overcome these limitations of NAND flash memory, a Flash File System (FFS) has been developed. The FFS provides a system of data storage and manipulation on devices that contain flash memory and that emulate data storage on a magnetic disk. Such FFS was disclosed in U.S. Pat. No. 5,937,425, and is hereby incorporated by reference as if fully set forth herein. All three types of non-volatile memory (EEPROM, NOR flash, and NAND flash) are currently in use, and the specific type is determined by the application. NAND flash memory is used mainly where mass storage is required, but due to its block access nature, software applications cannot run directly from NAND flash. When software applications must be executed directly from a memory device, NOR flash memory should be used. EEPROM is used where a relatively small amount of memory is required and data will be written at the byte level.

It is noted that memory block devices may be logically divided into several partitions, similar to magnetic disk partitions. Each partition behaves as a separate logical unit or disk. The flash controller that implements the FFS is usually also responsible for managing the device partitioning.

With some applications, an EEPROM device may be emulated using NOR flash memory; the emulated EEPROM enables writing a single byte to the NOR memory and erasing the NOR memory block when required. Emulated EEPROM may be implemented by hardware, firmware, or a combination of the two.

With some applications, the limited endurance of flash memory may be problematic, for example, in an operating system that uses a block device as virtual memory. In order to increase the amount of available Random Access Memory (RAM) for an application, the operating system may implement disk swapping. In disk swapping, the operating system saves some sections of its RAM to its mass storage device, and reloads the RAM data as soon as an application needs to access it. The mass storage area used as a swap area may have to withstand intensive read/erase/write or erase cycles, resulting in relatively high wear compared to other sections of the mass storage device that are used to store code or static data. Another example is a File (System) Allocation Table (FAT). The FAT is updated quite frequently, whenever a new file is created or the size of an existing file changes.

Extending the Life Span of Non-Volatile Memory Devices

Most systems that contain NAND flash implement a wear-leveling algorithm. Wear-leveling algorithms optimize the number of write operations that can be performed on each flash memory block. According to this algorithm, each flash memory block gets written to roughly an equivalent number of times. When a logical block is translated into a physical block, the same logical block may be written to different physical locations. Thus, wear leveling algorithms can be useful, in many situations, for extending the life span of flash memory devices without concomitantly reducing the amount of logically addressable memory available on the device.

U.S. Pat. No. 5,367,484 discloses an EEPROM device having a number of data storage blocks, where a selected block may be designated to provide “high endurance.” This selected block is placed in parallel with a similar redundant block using a switching unit, whereupon identical data is written simultaneously to the two blocks. According to the disclosure of U.S. Pat. No. 5,367,484, this redundancy increases the endurance of the selected blocks, because if only one of the selected block and the redundant block fails, it will still be possible to write data to the corresponding logical region. U.S. Pat. No. 5,793,684 discloses that if high reliability and redundancy are subsequently not required, a signal may be sent to the switching unit to disconnect the address locations of the first memory array from the corresponding address locations of the redundant second memory array to produce a memory device having an increased amount of address locations. There is no disclosure or suggestion of increasing the endurance level of memory other than EEPROM. Furthermore, the aforementioned patents do not disclose how much additional endurance the “high” endurance level provides, and there is no disclosure or teaching of configuring non-volatile memory to provide a requested endurance.

U.S. Patent Application 2003/0028733 discloses a memory apparatus having a volatile memory for storing data from a host, a nonvolatile memory capable of storing the data stored in the volatile memory, and electrically deleting the data, and a control circuit for controlling data transfer between the volatile memory and the nonvolatile memory. The memory device disclosed is a volatile memory device—e.g. a capacity of a data storage area of the volatile memory is larger than that of a data storage area of the nonvolatile memory. The device disclosed is volatile memory device having a relatively small non-volatile memory backup, and there is no disclosure of non-volatile memory devices as understood herein.

There is an ongoing need for improved non-volatile devices and methods for configuring non-volatile memory devices to provide improved memory endurances. It is noted that prior knowledge of approximately how many write or erase cycles a memory portion or entire non-volatile memory may reliably sustain allows for appropriate planning and device utilization. Thus, there is an ongoing need for devices that are configurable to provide a specific requested memory endurance.

### SUMMARY OF THE INVENTION

The aforementioned needs are satisfied by several aspects of the present invention.

It is now disclosed for the first time non-volatile memory device including a non-volatile memory and a controller operative to configure at least a portion of the non-volatile memory to provide a requested effective endurance. According to some embodiments, the requested effective endurance exceeds a native physical endurance of the at least a portion of the non-volatile memory.

According to some embodiments, the configuring of the at least a portion by the controller includes the steps of determining an amount of physical non-volatile memory to reserve for the at least a portion, where the determined amount exceeds a logical size of the at least a portion, and allocating the determined amount of physical memory.

Thus, in one example, it is requested that a logically addressable memory portion (e.g. 20 MB of memory) be configured to have an effective endurance equal a multiple (e.g. an “endurance multiple”) of the native physical memory (e.g. three). According to this specific example, a physical region of non-volatile memory (e.g. 60 MB of physical memory) is reserved to provide the requested effective endurance, and this physical region is subdivided into a number (e.g. three) of physical subregions equal to the endurance multiplier. In this specific example, the size of each subregion is identical to the size of the logically addressable memory portion (e.g. 20 MB of memory).

According to this example, a first request to write data to a specific logical address is handled by writing data to the appropriate location within a first subregion. Similarly, second and third requests to write data to the same specific logical address are handled by writing data to the respective locations in the second and third subregions. A fourth request to write data to the specific logical address is operative, once more, to write the data to the first subregion. Thus, in this example, by writing the data to different physical locations each time, any given physical location sustains a fraction (e.g. one divided by the endurance multiplier, or one third) of the number of write operations. Thus, the reserved region of physical memory, and concomitantly the logically addressable memory portions, provides the requested effective endurance.

Thus, according to some embodiments, each of a plurality of write operations to a given logical memory address is operative to write data to a different physical location in memory.

Furthermore, it is understood that according to the previous example, requesting an effective endurance that exceeds that native physical endurance (e.g. three times that physical endurance) results 60 MB of physical memory being reserved for 20 MB of logical storage. Thus, it is noted that, according to this example, the total amount of logically addressable memory decreases (e.g. by the difference between 60 MB and 20 MB, or 40 MB) upon memory configuration.

According to some embodiments, the allocation of the extended storage per partition and the management of each partition in a non-random access flash memory device are typically implemented as part of the FFS, but may be implemented by external applications, and/or may be supported by hardware. After allocating the desired amount of physical memory, each partition is managed in a way that is similar to how it was managed without this invention.

Thus, according to some embodiments, a total amount of logically addressable memory decreases upon the configuring to provide the increased effective endurance.

According to some embodiments, for a given amount of configured physical memory, requesting a greater effective endurance provides a smaller amount of logically addressable memory.

Alternatively or additionally, for a given amount of logically addressable memory, requesting a greater effective endurance configures a greater amount of physical non-volatile memory.

According to some embodiments, the amount is determined in accordance with a specified value of the requested effective endurance.

According to some embodiments of the present invention, it is possible to program the endurance of the non-volatile memory to a variety of levels, where the desired endurance is a tradeoff between the logical memory size and the extra endurance, so a minimum desired endurance level is provided or guaranteed.

According to some embodiments, the controller is operative to set the effective endurance to one of a plurality of values.

There is no limitation on how the effective endurance is requested. According to some embodiments, the controller is operative to configure the non-volatile memory in accordance with received parameters provided with an external command (e.g. a formatting command).

According to some embodiments, the device further includes an interface for receiving a value of requested effective endurance. In particular, according to some embodiments, the user interface for initializing the flash memory is enhanced and includes an entry for specifying the desired endurance level per each defined partition.

There is no limitation on the type of non-volatile memory to be configured in accordance with embodiments of the present invention, and it is noted that configuration of random access memory and configuration of non-random access memory to provide an effective endurance are both within the scope of the present invention. Appropriate non-volatile memory includes but is not limited to NAND flash memory, NOR flash memory and EEPROM memory. Nevertheless, it is noted that in various embodiments, the specific algorithm used to configure to provide the effective endurance may vary, depending on the type of non-volatile memory.

According to some embodiments, the device is operative to emulate EEPROM memory.

According to some embodiments, the controller is operative to configure all of the non-volatile memory to provide the requested effective endurance.

According to some embodiments, the controller is operative to write data to the allocated physical memory, and at least one writing includes writing given data only once to the allocated physical memory.

According to some embodiments, the controller is operative to set the effective endurance to a first value for a first portion of the non-volatile memory, and is operative to set the effective endurance to a second value different from the first value for a second portion of the non-volatile memory.

According to some embodiments, the controller includes embedded software and the configuring is effected at least in part by the embedded software.

Although certain embodiments of the present invention have been explained in terms of a memory device controller configuring the non-volatile memory to provide the requested effective endurance, this is not a limitation of the present invention. The memory configuration can be implemented by hardware, software, firmware, or any combination thereof, residing on any device or devices. The memory configuration can be applied to off-the-shelf memory devices by enhancing the control firmware or to the glue logic connecting the device to the processing unit or bus.

It is now disclosed for the first time a system for data storage including a non-volatile memory device including a non-volatile memory, a host device coupled to the non-volatile memory device and driver code residing on the host device, where the driver code operative to configure at least a portion of the non-volatile memory to provide a requested effective endurance.

It is now disclosed for the first time method for setting an effective memory endurance. The presently disclosed method includes issuing a command to set an effective endurance of a non-volatile memory device including non-volatile memory and configuring at least a portion of the non-volatile memory to provide the requested effective endurance.

According to some embodiments, the command is an external command issued by a host device coupled to the non-volatile memory device.

According to some embodiments, the effective endurance exceeds a physical endurance of the at least a portion of the non-volatile memory.

According to some embodiments, the configuring includes reducing a total amount of logically addressable memory of the non-volatile memory device.

According to some embodiments, the effective endurance is set at the time of manufacture or a time of formatting of the non-volatile memory device.

According to some embodiments, the effective endurance is set at a runtime of the non-volatile memory device.

According to some embodiments, the setting of the effective endurance is effected at least in part by software embedded within the non-volatile memory device.

According to some embodiments, the setting of the effective endurance is effected at least in part by software residing on a host computer coupled to the non-volatile memory device.

It is now disclosed for the first time computer readable storage medium having computer readable code embodied in the computer readable storage medium, the computer readable code comprising instructions to configure at least a portion of a non-volatile memory of a non-volatile memory device to provide a requested effective endurance.

These and further embodiments will be apparent from the detailed description and examples that follow.

### BRIEF DESCRIPTION OF THE DRAWINGS

FIG. 1A provides a block diagram of an exemplary non-volatile memory device according to exemplary embodiments of the present invention.

FIG. 1B illustrates an exemplary implementation of a device partitioning routine of non-random access memory such as NAND flash to provide an effective endurance.

FIG. 2 provides a flow chart of an exemplary routine wherein at least a portion of a non-volatile memory is configured to provide a specified endurance.

FIG. 3 provides a simplified flowchart of an exemplary flash memory management algorithm.

FIG. 4 illustrates an exemplary implementation of a routine for configuring non NOR flash to provide an effective endurance.

FIG. 5 is a flowchart that describes a write operation to a random access device according to exemplary embodiments of the present invention.

FIG. 6 describes an exemplary read process.

FIG. 7 illustrates an exemplary hardware implementation of the mapping table.

### DETAILED DESCRIPTION OF THE INVENTION

The present invention will now be described in terms of specific, example embodiments. It is to be understood that the invention is not limited to the example embodiments disclosed. It should also be understood that not every feature of the non-volatile memory devices operative to configure memory to provide a requested effective endurance, systems for data storage, methods for setting effective memory endurance, and computer readable code described is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

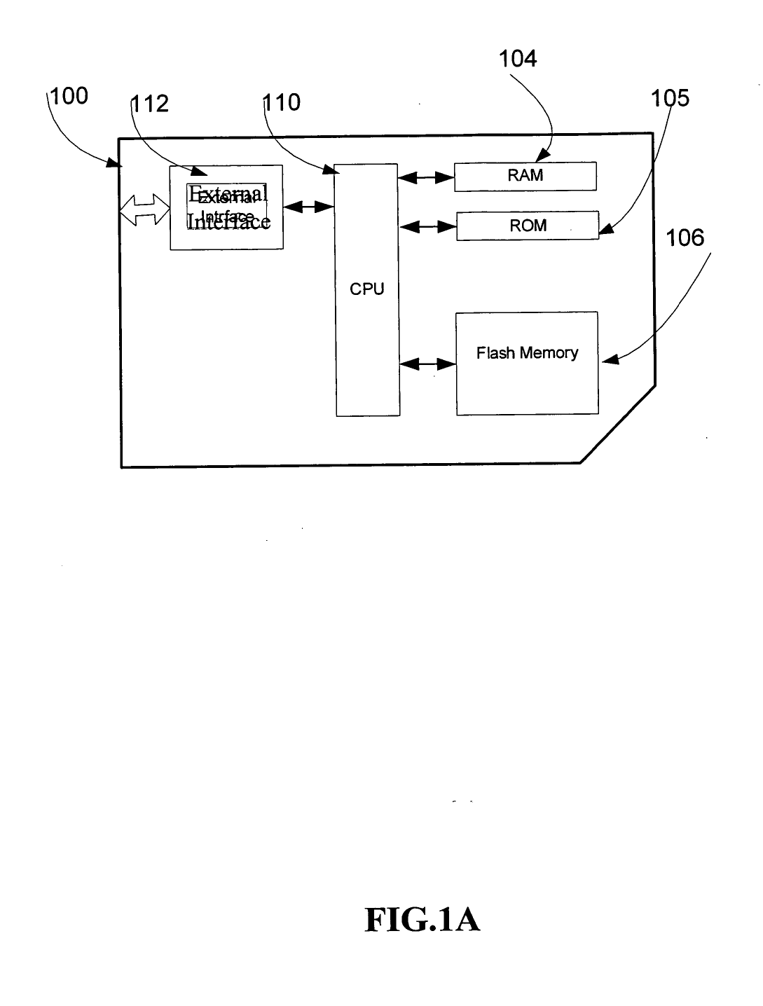

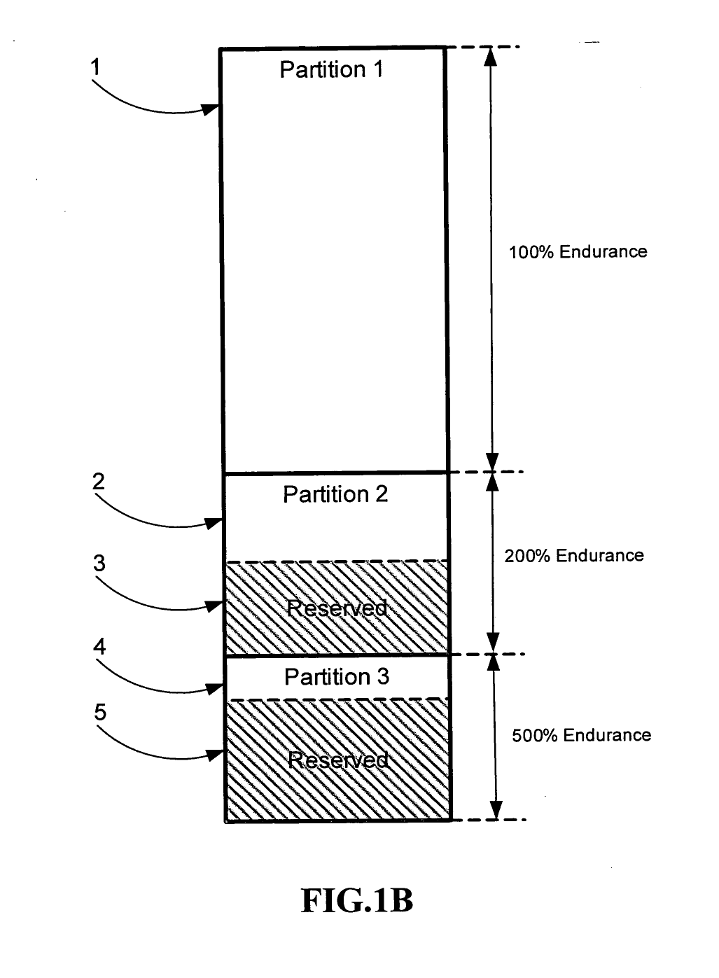

FIG. 1A provides a block diagram of an exemplary non-volatile memory device (100) according to exemplary embodiments of the present invention. According to FIG. 1A, data and commands are received from a host device (note shown) through an external interface (112). A central processing unit (110) stores data in non-volatile memory (e.g. flash memory (106)) of the device. The CPU (110) makes use of ROM and volatile memory (e.g. the RAM (104)) when managing the device. Because the volatile memory is primarily used for device management and not for data storage, the size of the volatile memory is typically much smaller (e.g. at least one order of magnitude) than the size of the non-volatile memory.

Throughout this disclosure, “a non-volatile memory device” refers to a device where a majority of the memory provided in the device is non-volatile memory. Examples of non-volatile memory devices include smartcard devices, memory cards, MultiMediaCards and the like. In some embodiments, a “non-volatile memory device” includes both volatile and non-volatile memory, and a ratio between size of the non-volatile memory and a size of the volatile memory is, for example, at least 10, or, for example, at least 100.

FIG. 1B illustrates an exemplary implementation of a routine for configuring non-random access memory such as NAND flash to provide an effective endurance. According to this example, the memory is divided into three portions. The first partition (1) is used to store mostly static data; as there is no requirement for enhanced endurance, this memory partition is managed using legacy means. The second partition (2) is used for more dynamic data storage (e.g. database storage), so its desired endurance is higher then the native memory endurance, 200% in this example. In order to ensure higher endurance, the physical memory size assigned for this partition is twice the logical size. A reserved area (3) is added to this partition; the reserved area size is the same size as the size of the required area so we achieve a minimum endurance level of 200% (see the explanation below for calculating the minimum endurance).

A third memory partition (4) is defined in a way similar to the previous partition (2), but with this third partition the required endurance is five times the nominal endurance, the physical memory size is 5 times the logical area, and the reserved area (5) is 4 times the required capacity. Since the flash management application writes to a different location each time, the endurance of this partition is guaranteed to be at least 5 times the minimum native device endurance.

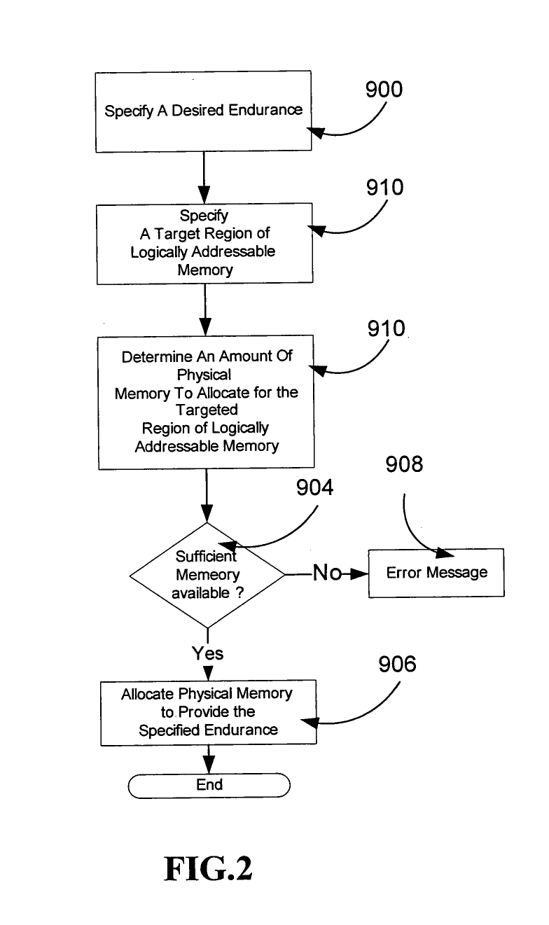

FIG. 2 provides a flow chart of an exemplary routine wherein at least a portion of a non-volatile memory is configured to provide a specified endurance. According to the example of FIG. 2, an effective endurance is specified (900) (for example, by a user operating a host device coupled to the memory device) for a specified (910) target region of logically addressable memory. It is noted that the effective endurance can be specified (900) in a number of ways. In one non-limiting example, an “endurance multiplier,” indicative of a ratio between the requested endurance and the native endurance, is specified.

It is intended to configure the device so that it is possible to reliably write to addresses within the target region of logically addressable memory (910) at least a number of times as specified by the effective endurance (900). Towards this end, a determination (902) is made (for example, by firmware of the non-volatile memory device) of how much physical memory needs to be allocated for the targeted region of logically addressable memory. There is no limitation on how this determination is made (902), and any technique known in the art is appropriate for these embodiments of the present invention (e.g. by computing this number from the specified effective endurance and the size of the target region of logically addressable memory, using a lookup table, etc.).

In the event that enough physical memory is available (904), the device controller allocates (906) the physical memory to provide the specified endurance (906)—e.g. where the physical memory size is the logical size multiplied by the ratio of the desired endurance (900) divided by the device native endurance.

If insufficient physical memory is available (904), an error message (906) is optionally generated and, for example, transmitted to the host device. According to some embodiments, as soon as the system writes to the device, the device control searches for the next free area and maps the logical block or memory location to a physical location that stores the data. The logical-to-physical map is kept in a mapping table that can be a hardware-based memory map or implemented by firmware. The mapping table is backed up in a special section of the non-volatile memory and reloaded at power-up time.

The following paragraphs provide a detailed description of the method as applicable for each major type of non-volatile memory.

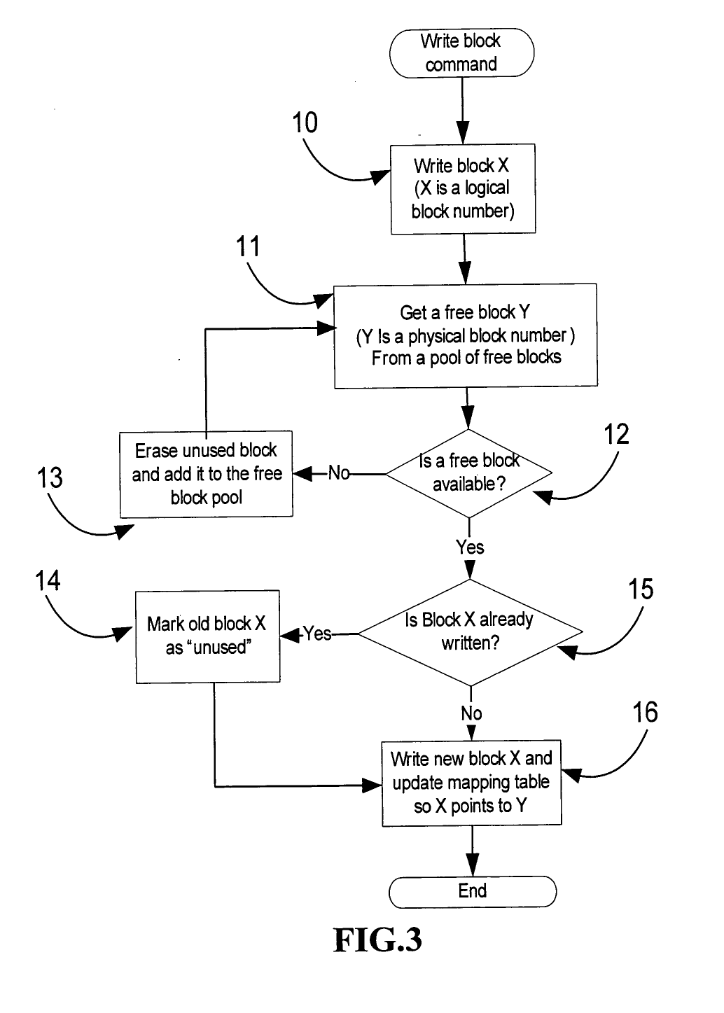

FIG. 3 provides a simplified flowchart of an exemplary flash memory management algorithm; this simplified flow is used to illustrate the providing of increased endurance. In practice, a more sophisticated algorithm such as the one described in U.S. Pat. No. 5,937,425 may also be implemented. A write block command (10) specifies a logical block number X to be written to the flash memory. In order to write this block, the flash management logic allocates a free block from a pool of free blocks. This free block number has a physical address Y (11). If the list of free blocks is empty (12) the flash management searches the memory for an unused block, erases it, and adds it to the list of free blocks (13). With some flash management implementations, more than one free block may be erased at the same time, and in other implementations the erase may be performed as a background operation. The flash management verifies if the logical block X has been already written, meaning whether it has already been mapped to a physical block (15). If yes, the old physical block is marked as “unused” (14), and is added to the list of free blocks as soon as it is erased. Finally, the logical block X is written to physical location Y and the mapping table is updated so logical block X points to Y (16).

If the amount of physical memory allocated to a partition is y and the logical partition size is x, by writing n times to the flash memory each location will be written n×(x÷y) times on average. As long as free blocks are available, these blocks will be used for storing new data. As a result, if the flash memory endurance is e write or erase cycles, the minimum new endurance level will be el=e÷(x÷y). For example, assume that y=20 and x=10. Initially, all blocks are free so writing to logical blocks 0-9 causes the FFS write to physical blocks 0-9. If data is written to logical blocks 0-9 again, the FFS will write the data to physical blocks 10-19. So far, each physical block has been written once, while each logical block has been written twice. If we repeat this process over and over, the wear of the logical memory is double the wear of the native physical memory, or we can say that the endurance is doubled. Assuming that e=10,000, using the above formula to calculate the average logical endurance results 10,000÷(10÷20)=20,000, which is twice the native physical memory endurance. In practice, the actual endurance will be much higher than the minimum calculated endurance because as soon as a block is worn out, it is put aside (marked as a bad block) and not used any more. Since there are many redundant blocks, the flash memory is usable as long as the physical amount of memory is larger then the logical memory size. As soon as the amount of the physical memory falls below a certain level, a warning message may be generated to warn the user that the memory device must be replaced. The extra endurance we may get due to bad block detection is highly dependent on the nature of the application using the flash memory and the properties of the device. With typical devices this extra endurance may add up to ten times the native device endurance where the physical memory size is only twice of the logical size.

A similar method can be implemented for NOR flash. Unlike NAND flash, NOR flash read is similar to random access, read-only memory. In exemplary embodiments, the implementation of configurable endurance for NOR flash memory includes a software layer to receive read/write requests and perform the physical read/write operations. By implementing some of the logic in hardware, it may be possible to read directly from the memory device and to execute applications directly from the NOR flash memory.

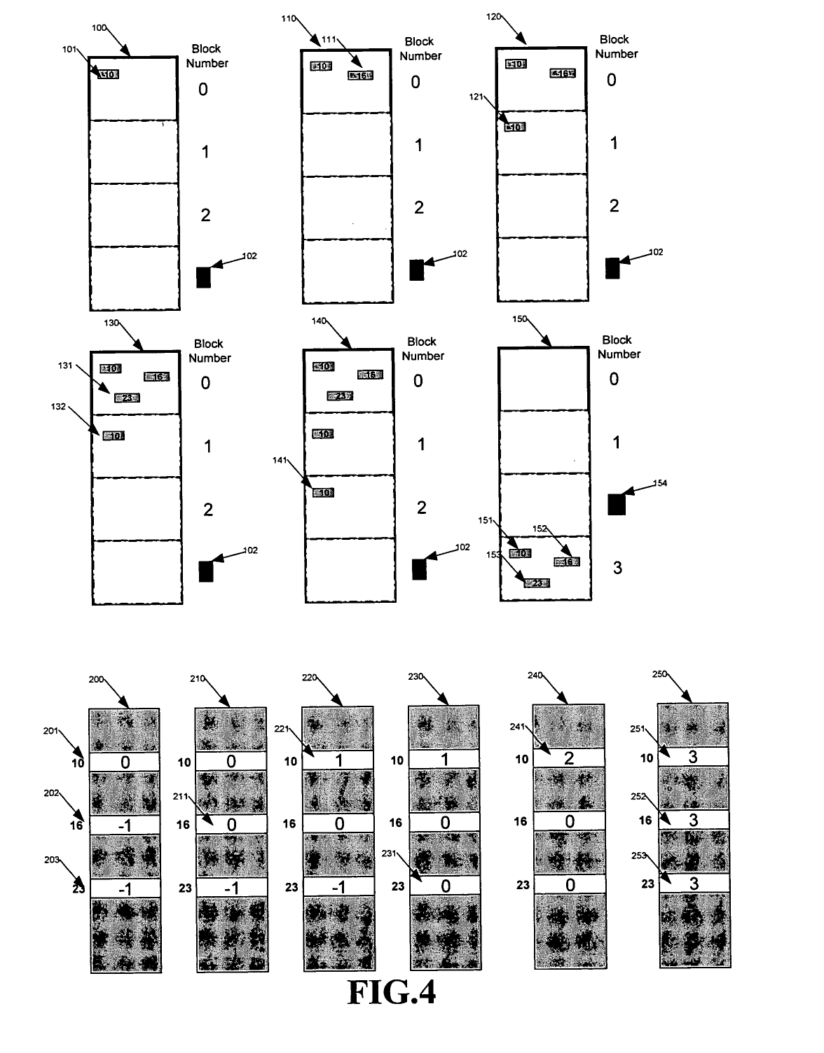

FIG. 4 illustrates an exemplary implementation of a routine for configuring NOR flash to provide an effective endurance. Subfigures (100), (110), (120), (130), (140) and (150) illustrate different states of the NOR flash memory contents while sub-figures (200), (210), (220), (230), (240) and (250) describe the corresponding states of the address mapping table. A section of the NOR flash memory (101) that needs a higher endurance level is divided into four sections numbered 0, 1, 2 and 3. The size of each of the four sections is set equal to the desired size of the logical memory. In this example, the physical memory is four times larger than the size of the logical memory. Initially, all blocks are erased. In this example, we want to write new data to logical memory location 10. Since memory block 0 is erased the data is written to block 0 (101), and 0 is also recorded in a mapping table (200) at location 10 (201), meaning logical location 10 mapped to block 0. All other mapping table locations are initially set to −1 (202), (203), which indicates that these entries are not in use. Writing to a new location (111) is performed similarly and the mapping table (211) is updated accordingly. As soon as logical address 10 needs to be written again, it is written to the next physical block (121) and the mapping table is updated accordingly (221). If data is written to a new location that has not been written previously, block 0 is used (131). Writing location 10 again will set the block number of this address to 2 (141), (241). After writing location 10 to the first 3 blocks, the next time address 10 is written (150), all the data from all previously written locations is copied to the forth block (102) and the first 3 blocks are erased (151), (152), (153) to make room for new data. The mapping table is updated accordingly (251), (252), (253). Up until this point, block 3 has been last and block 0 has been first; after the data is copied, the block order is rearranged as 3, 0, 1, 2 so that block 3 is now first and block 2 is last (154).

When a memory read operation is performed, the memory map is first read and the block number related to the desired location is extracted. The data is then read from the block number to which the mapping table points.

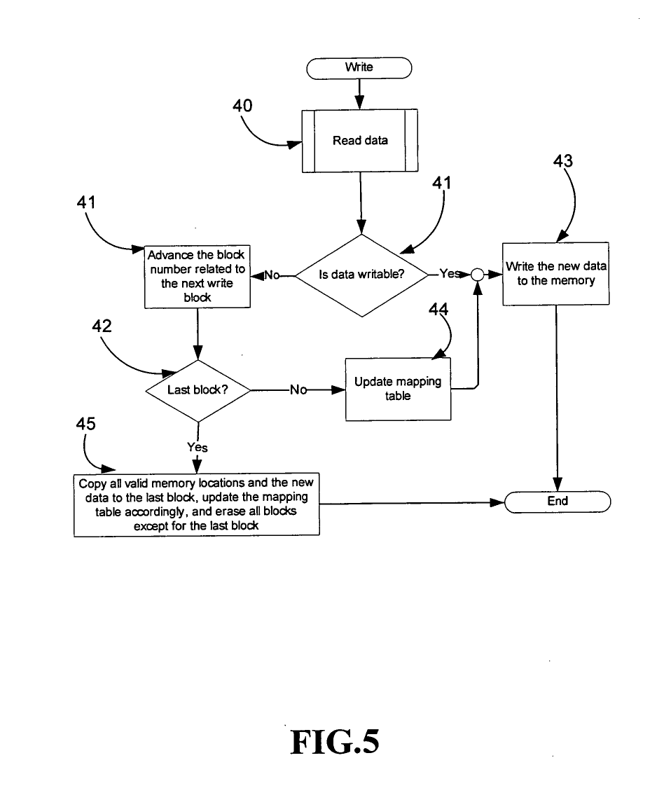

FIG. 5 is a flowchart that describes a write operation to a random access device according to exemplary embodiments of the present invention. The write process starts with the FFS reading the relevant memory location (40) and testing if this location is writable (41). A memory location is writable if the new data does not require setting any of its bits from “0” to “1”, for example, an erased area of memory contains all ones so it is always writable. A memory byte that has been written with hex F0 may be changed to 00, but not to FF. If the data is writable, the new data is written to the desired location (43), otherwise the FFS advances the current block number (42) and checks whether it is the last block (42). If it is not the last block, the mapping table is updated (44), and then the FFS writes the data to memory. Since the new block is erased, this logical location within the next block is writable. If this is the last block, all previously written data from all other blocks is copied to the last block, all memory blocks except for the last block are erased, and the mapping table is updated so all logical addresses point to the last memory block (45).

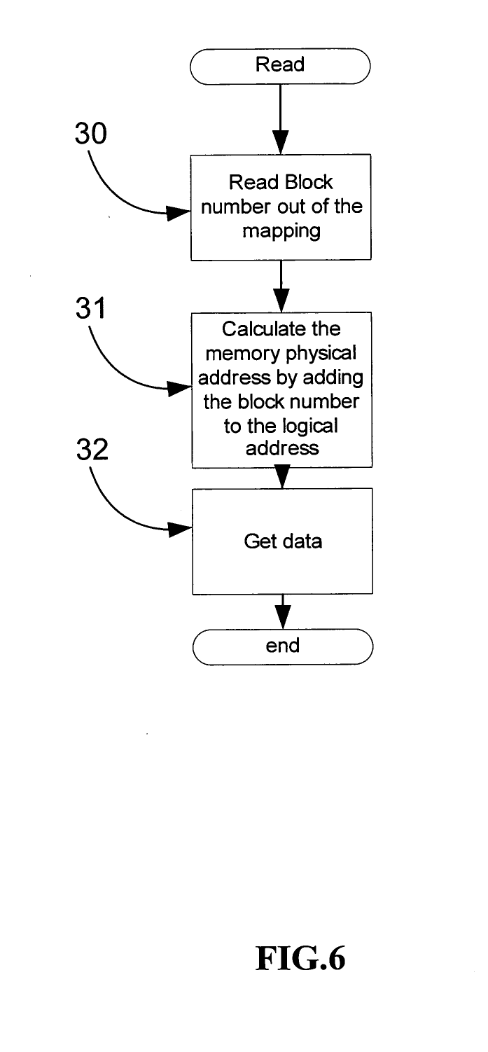

FIG. 6 describes an exemplary read process. According to embodiments illustrated in FIG. 6, in order to read a memory location, the FFS first reads the mapping table and gets the relevant block number (30), and then the physical memory address is calculated by combining the logical address with the block number (31). After this calculation, the desired data is read (32).

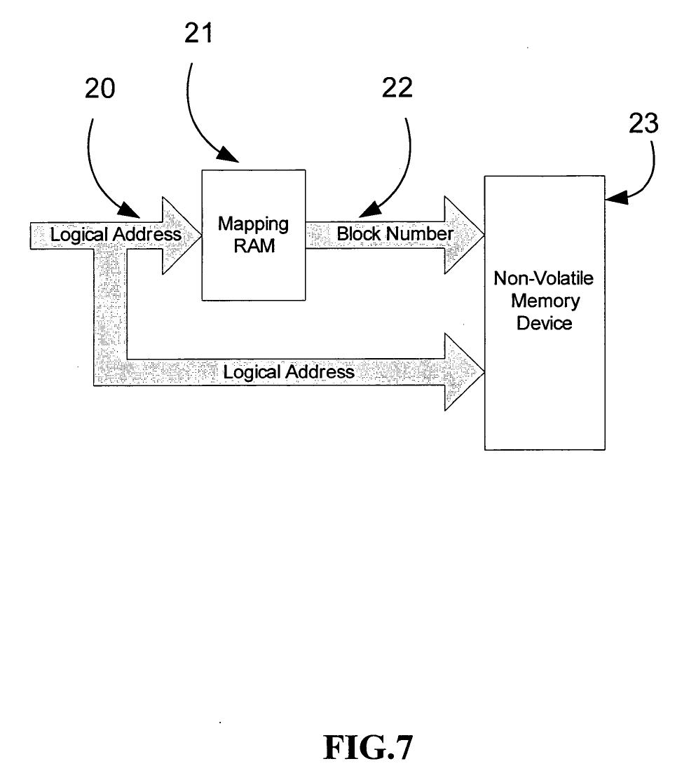

FIG. 7 illustrates an exemplary hardware implementation of the mapping table. A mapping RAM (21) is used to store the block number for each memory location. The logical address (20) is applied to the mapping RAM address bus, and the data bus of the mapping RAM provides the block number as the high address bits (22) to the non-volatile memory (23). Hardware implementation of the mapping RAM provides a fast read access time and preserves the NOR flash property of executing code directly from memory.

In order to reduce the size of mapping table, several memory addresses might be grouped together. For example, every 32 consecutive memory addresses can be grouped, which reduces the mapping table size by 1/32 so there are five less mapping RAM address bits (the five Least Significant address bits are not applied to the mapping RAM). The previously described algorithm works almost the same way, except that every time the block number changes all valid memory locations that belong to the same group must be copied to the next block. For example, if the group size is 32 bytes, writing a second time to memory location 35 will require copying memory locations 32-34 and 36-63 (all belonging to the same group) to the next block.

The same method is also applicable for EEPROM, except that there is no need to perform erase before write. As such, each time the same logical memory location is updated, the data is written to the next memory block.

Calculating the new endurance for a random access device is the same as explained previously for a non-random access device. As with the non-random access device, the minimum guaranteed endurance is in direct proportion to the ratio of the physical memory size and the logical memory size.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

What is claimed is:

1) A non-volatile memory device comprising:
a) a non-volatile memory; and
b) a controller operative to configure at least a portion of said non-volatile memory to provide a requested effective endurance.

2) The non-volatile memory device of claim 1 wherein said effective endurance exceeds a physical endurance of said at least a portion of said non-volatile memory.

3) The non-volatile memory device of claim 1 wherein a total amount of logically addressable memory decreases upon said configuring to provide an increased said effective endurance.

4) The non-volatile memory device of claim 1 wherein said configuring of said at least a portion by said controller includes:
i) determining an amount of physical non-volatile memory to reserve for said at least a portion, said determined amount exceeding a logical size of said at least a portion; and
ii) allocating said determined amount of physical memory.

5) The non-volatile memory device of claim 4 wherein, for a given amount of configured said physical memory, requesting a greater effective endurance provides a smaller amount of logically addressable memory.

6) The non-volatile memory device of claim 4 wherein, for a given amount of logically addressable memory, requesting a greater effective endurance configures a greater amount of said physical non-volatile memory.

7) The non-volatile memory device of claim 4, wherein said amount is determined in accordance with a specified value of said requested effective endurance.

8) The non-volatile memory device of claim 4 wherein said controller is operative to write data to said allocated physical memory, and at least one said writing includes writing given data only once to said allocated physical memory.

9) The non-volatile memory device of claim 1 wherein said controller is operative to set said effective endurance to one of a plurality of values.

10) The non-volatile memory device of claim 1 further comprising;
c) an interface for receiving a value of said requested effective endurance.

11) The non-volatile memory device of claim 1 wherein said non-volatile memory includes NAND flash memory.

12) The non-volatile memory device of claim 1 wherein said non-volatile memory includes NOR flash memory.

13) The non-volatile memory device of claim 1 wherein said non-volatile memory includes EEPROM memory.

14) The non-volatile memory device of claim 1 wherein said device is operative to emulate EEPROM memory.

15) The non-volatile memory device of claim 1 wherein said controller is operative to configure all of said non-volatile memory to provide said requested effective endurance.

16) The non-volatile memory device of claim 1 wherein said controller is operative to set said effective endurance to a first value for a first said portion of said non-volatile memory, and is operative to set said effective endurance to a second value different from said first value for a second said portion of said non-volatile memory.

17) The non-volatile memory device of claim 1 wherein said controller is operative to configure said non-volatile memory in accordance with a received external command.

18) The non-volatile memory device of claim 1 wherein said controller includes embedded software and said configuring is effected at least in part by said embedded software.

19) A system for data storage comprising:
a) a non-volatile memory device including a non-volatile memory;
b) a host device coupled to said non-volatile memory device; and
c) driver code residing on said host device, said driver code operative to configure at least a portion of said non-volatile memory to provide a requested effective endurance.

20) A method for setting an effective memory endurance, the method comprising:
a) issuing a command to set an effective endurance of a non-volatile memory device including non-volatile memory; and
b) configuring at least a portion of said non-volatile memory to provide said requested effective endurance.

21) The method of claim 20 wherein said command is an external command issued by a host device coupled to said non-volatile memory device.

22) The method of claim 20 wherein said effective endurance exceeds a physical endurance of said at least a portion of said non-volatile memory.

23) The method of claim 20 wherein said configuring includes reducing a total amount of logically addressable memory of said non-volatile memory device.

24) The method of claim 20 wherein said configuring of said at least a portion includes the steps:
i) determining an amount of physical non-volatile memory to reserve for said at least a portion, said determined amount exceeding a logical size of said at least a portion; and
ii) allocating said determined amount of physical memory.

25) The method of claim 24 wherein for a given amount of logically addressable memory, requesting a greater said effective endurance allocates a greater amount of said physical non-volatile memory.

26) The method of claim 24 wherein, for a given amount of said physical non-volatile memory, requesting a greater said effective endurance provides a smaller amount of logically addressable memory.

27) The method of claim 24, wherein said amount is determined in accordance with a specified value of said requested effective endurance.

28) The method of claim 24 further comprising:
c) writing data to said allocated physical memory such that said writing includes writing given data only once to said allocated physical memory.

29) The method of claim 20 wherein said effective endurance is set at the time of manufacture of said non-volatile memory device.

30) The method of claim 20 wherein said effective endurance is set at a runtime of said non-volatile memory device.

31) The method of claim 20 wherein said setting of said effective endurance is effected at least in part by software embedded within said non-volatile memory device.

32) The method of claim 20 wherein said setting of said effective endurance is effected at least in part by software residing on a host computer coupled to said non-volatile memory device.

33) The method of claim 20 wherein said non-volatile memory device includes NAND flash memory.

34) The method of claim 20 wherein said non-volatile memory device includes NOR flash memory.

35) The method of claim 20 wherein said non-volatile memory device includes EEPROM memory.

36) The method of claim 20 wherein said non-volatile memory device is operative to emulate EEPROM memory.

37) A computer readable storage medium having computer readable code embodied in said computer readable storage medium, said computer readable code comprising instructions to configure at least a portion of a non-volatile memory of a non-volatile memory device to provide a requested effective endurance.
